(19) United States
(12) Patent Application Publication
(10) Pub. No.: US 2026/0072196 A1
(43) Pub. Date: Mar. 12, 2026

(54) OBSTACLE PROXIMITY DETECTION DEVICE, OBSTACLE PROXIMITY DETECTION METHOD, AND OBSTACLE PROXIMITY DETECTION PROGRAM

(71) Applicant: NIPPON TELEGRAPH AND TELEPHONE CORPORATION, Tokyo (JP)

(72) Inventors: Yusuke SAKURAHARA, Tokyo (JP); Yukihiro GOTO, Tokyo (JP); Nobuyuki OKANO, Tokyo (JP); Kenji INOUE, Tokyo (JP)

(73) Assignee: NIPPON TELEGRAPH AND TELEPHONE CORPORATION, Tokyo (JP)

(21) Appl. No.: 19/105,323

(22) PCT Filed: Aug. 24, 2022
(86) PCT No.: PCT/JP2022/031959

§ 371 Date: Feb. 20, 2025

(51) Int. Cl. G01V 8/12

(52) U.S. Cl. CPC G01V 8/12

(57) ABSTRACT

An obstacle proximity detection device includes: an acquisition unit configured to sequentially acquire three-dimensional point cloud data representing an outdoor structure acquired by a three-dimensional laser scanner; a specifying unit configured to specify first point cloud data representing an object and second point cloud data representing an obstacle from the three-dimensional point cloud data; a setting unit configured to set a first detection area that is an area set in advance by a user and is an area around the first point cloud data; a moving unit configured to move, on the basis of a feature point extracted from the first point cloud data, the first point cloud data and the first detection area according to movement of the feature point; and an output unit configured to output an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

### TECHNICAL FIELD

The disclosed technology relates to an obstacle proximity detection device, an obstacle proximity detection method, and an obstacle proximity detection program.

### BACKGROUND ART

Patent Literature 1 discloses a three-dimensional space specifying device, a method, and a program for accurately specifying a three-dimensional space in which an object to be detected exists.

In addition, Patent Literature 2 discloses a facility state detection method, a detection device, and a program that enable simple and accurate comparison and confirmation between a three-dimensional model and an actual facility state without requiring skill of a worker.

### CITATION LIST

### Patent Literature

Patent Literature 1: JP 2018-97588 A
Patent Literature 2: JP 2018-195240 A

### SUMMARY OF INVENTION

### Technical Problem

When a construction such as newly erecting a utility pole or the like, which is an example of an object, is performed, the utility pole is often moved during the construction. In this case, it is not preferable that the moving utility pole and other obstacles come close to each other.

The technique disclosed in Patent Literature 1 is a technique for analyzing a point cloud including three-dimensional points included in a three-dimensional space where facilities around a road exists and detecting the facilities around the road. In addition, the technique disclosed in Patent Literature 2 is a technique for generating 3D model data of a facility on the basis of point cloud data of the facility acquired by laser scanning, and calculating thickness, inclination angle, and deflection of poles and trees and minimum ground height of cables on the basis of the 3D model data.

For this reason, even if the techniques disclosed in Patent Literatures 1 and 2 are used, there is a problem that it is not possible to detect proximity of a moving object to another obstacle in real time.

The disclosed technology has been made in view of the above points, and an object thereof is to provide an obstacle proximity detection device, an obstacle proximity detection method, and an obstacle proximity detection program capable of detecting proximity between a moving object and another obstacle in real time.

### Solution to Problem

The first aspect of the present disclosure is an obstacle proximity detection device, which includes: an acquisition unit configured to sequentially acquire three-dimensional point cloud data representing an outdoor structure acquired by a three-dimensional laser scanner; a specifying unit configured to specify first point cloud data representing an object and second point cloud data representing an obstacle from the three-dimensional point cloud data; a setting unit configured to set a first detection area that is an area set in advance by a user and is an area around the first point cloud data; a moving unit configured to move, on the basis of a feature point extracted from the first point cloud data, the first point cloud data and the first detection area according to movement of the feature point; and an output unit configured to output an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

The second aspect of the present disclosure is an obstacle proximity detection method in which a computer executes processing of: sequentially acquiring three-dimensional point cloud data representing an outdoor structure acquired by a three-dimensional laser scanner; specifying first point cloud data representing an object and second point cloud data representing an obstacle from the three-dimensional point cloud data; setting a first detection area that is an area set in advance by a user and is an area around the first point cloud data; moving, on the basis of a feature point extracted from the first point cloud data, the first point cloud data and the first detection area according to movement of the feature point; and outputting an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

The third aspect of the present disclosure is an obstacle proximity detection program for causing a computer to execute processing of: sequentially acquiring three-dimensional point cloud data representing an outdoor structure acquired by a three-dimensional laser scanner; specifying first point cloud data representing an object and second point cloud data representing an obstacle from the three-dimensional point cloud data; setting a first detection area that is an area set in advance by a user and is an area around the first point cloud data; moving, on the basis of a feature point extracted from the first point cloud data, the first point cloud data and the first detection area according to movement of the feature point; and outputting an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

### Advantageous Effects of Invention

According to the disclosed technology, there is an effect of detecting proximity between a moving object and another obstacle in real time.

### BRIEF DESCRIPTION OF DRAWINGS

FIG. 1 is a block diagram illustrating an example of a hardware configuration of an obstacle proximity detection device according to an embodiment.

FIG. 2 is a block diagram illustrating an example of a functional configuration of the obstacle proximity detection device according to the embodiment.

FIG. 3 is a diagram illustrating a relationship between the obstacle proximity detection device and a three-dimensional laser scanner.

FIG. 4 is a flowchart for describing an operation of the obstacle proximity detection device according to the embodiment.

FIG. 5 is a flowchart for describing an operation of the obstacle proximity detection device according to the embodiment.

FIG. 6 is a flowchart for describing an operation of the obstacle proximity detection device according to the embodiment.

FIG. 7 is a diagram for describing an operation of the obstacle proximity detection device according to the embodiment.

FIG. 8 is a diagram for describing an operation of the obstacle proximity detection device according to the embodiment.

FIG. 9 is a flowchart for describing an operation of the obstacle proximity detection device according to the embodiment.

FIG. 10 is a flowchart for describing an operation of the obstacle proximity detection device according to the embodiment.

FIG. 11 is a diagram for describing an operation of the obstacle proximity detection device according to the embodiment.

FIG. 12 is a flowchart for describing an operation of the obstacle proximity detection device according to the embodiment.

FIG. 13 is a flowchart for describing an operation of the obstacle proximity detection device according to the embodiment.

FIG. 14 is a diagram for describing an operation of the obstacle proximity detection device according to the embodiment.

FIG. 15 is a flowchart for describing an operation of the obstacle proximity detection device according to the embodiment.

FIG. 16 is a flowchart for describing an operation of the obstacle proximity detection device according to the embodiment.

FIG. 17 is a flowchart for describing an operation of the obstacle proximity detection device according to the embodiment.

FIG. 18 is a flowchart for describing an operation of the obstacle proximity detection device according to the embodiment.

FIG. 19 is a diagram for describing an operation of the obstacle proximity detection device according to the embodiment.

FIG. 20 is a diagram for describing a conventional technique.

FIG. 21 is a diagram for describing a conventional technique.

### DESCRIPTION OF EMBODIMENTS

Hereinafter, description of an example of embodiments of the disclosed technology will be described with reference to the drawings. Note that in the drawings, the same or equivalent components and portions will be denoted by the same reference signs. Moreover, dimensional ratios in the drawings are exaggerated for convenience of description and thus may be different from actual ratios.

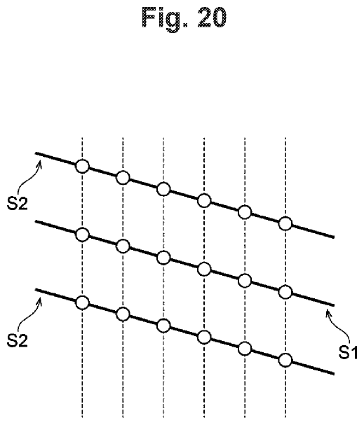

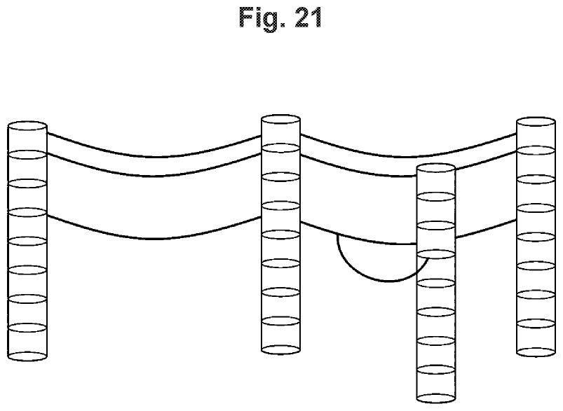

FIGS. 20 and 21 are diagrams for describing a conventional technique. As illustrated in FIG. 20, a technique for three-dimensionally modeling an outdoor structure by a three-dimensional laser scanner (mobile mapping system: MMS) equipped with an outdoor structure is known. FIG. 20 illustrates scan lines and three-dimensional point cloud data acquired by the MMS. As illustrated in FIG. 20, in the MMS, for example, a scan line and three-dimensional point cloud data S1 are created in a space where no three-dimensional point cloud data exists on the basis of already acquired scan line and three-dimensional point cloud data S2. Then, for example, in the MMS, a three-dimensional model is generated by integrating these pieces of three-dimensional point cloud data. As a result, even when the three-dimensional point cloud data is in a coarse state, the three-dimensional model is generated with high accuracy. Therefore, for example, even when a three-dimensional laser scanner is mounted on a vehicle and speed of the vehicle is high, a three-dimensional model of an outdoor structure around the vehicle can be accurately generated. For example, as the three-dimensional model of the outdoor structure, a three-dimensional model of utility poles and cables as illustrated in FIG. 21 is generated.

When a construction such as newly erecting a utility pole or the like, which is an example of an object, is performed, the utility pole is often moved during the construction. In this case, it is not preferable that the moving utility pole and other obstacles come close to each other.

However, the technique disclosed in Patent Literature 1 requires a time to create a scan line and generate a three-dimensional model, and thus it is difficult to detect an object in real time. Further, in the technique disclosed in Patent Literature 2, a detection area is designated in advance and in a case where a certain degree of three-dimensional point cloud data can be acquired, the three-dimensional point cloud data is detected as an object, and a behavior of the object is detected. Therefore, it is difficult to accurately detect proximity and contact between two objects.

Therefore, in the present embodiment, a behavior of an object under construction is monitored, proximity or contact between the object moved under construction and another obstacle is detected in real time, and a worker of the construction is notified.

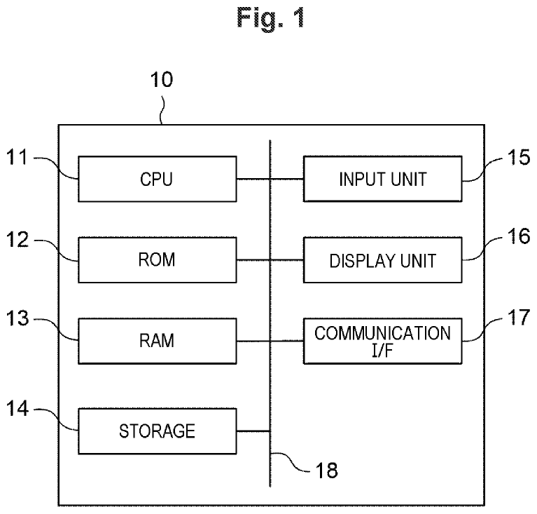

First, a hardware configuration of an obstacle proximity detection device 10 according to the present embodiment will be described with reference to FIG. 1.

FIG. 1 is a block diagram illustrating an example of a hardware configuration of the obstacle proximity detection device 10 according to the present embodiment.

As illustrated in FIG. 1, the obstacle proximity detection device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 18.

The CPU 11 is a central processing unit and executes various programs and controls each unit. That is, the CPU 11 reads a program from the ROM 12 or the storage 14, and executes the program using the RAM 13 as a working area. The CPU 11 controls each of the above-described components and performs various types of arithmetic processing in accordance with the program stored in the ROM 12 or the storage 14. In the present embodiment, an obstacle proximity detection program is stored in the ROM 12 or the storage 14.

The ROM 12 stores various programs and various types of data. The RAM 13 temporarily stores the programs and data as a working area. The storage 14 includes a hard disk drive (HDD) or a solid state drive (SSD) and stores various programs including an operating system and various types of data.

The input unit 15 includes a pointing device such as a mouse and a keyboard and is used to perform various inputs to own device.

The display unit 16 is, for example, a liquid crystal display and displays various types of information. The display unit 16 may function as the input unit 15 by adopting a touch panel system.

The communication interface 17 is an interface through which own device communicates with another external device. For the communication, for example, a wired communication standard such as Ethernet (registered trademark) or fiber distributed data interface (FDDI), or a wireless communication standard such as 4G, 5G, or Wi-Fi (registered trademark) is used.

For example, a general-purpose computer device such as a server computer or personal computer (PC) is applied to the obstacle proximity detection device 10 according to the present embodiment.

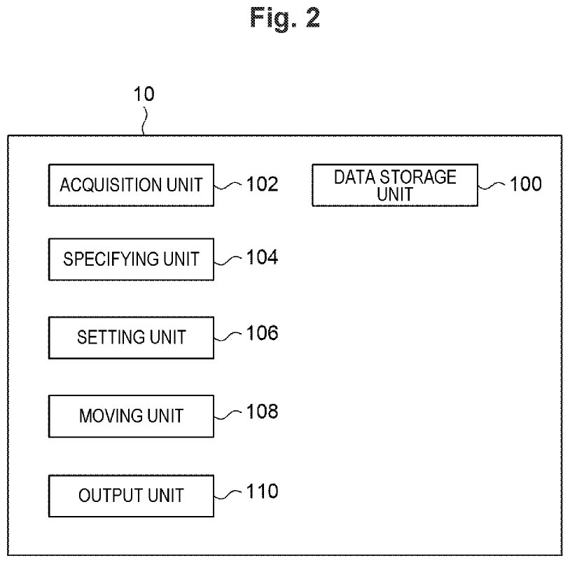

Next, a functional configuration of the obstacle proximity detection device 10 will be described with reference to FIG. 2.

FIG. 2 is a block diagram illustrating an example of a functional configuration of the obstacle proximity detection device 10 according to the present embodiment.

As illustrated in FIG. 2, the obstacle proximity detection device 10 includes a data storage unit 100, an acquisition unit 102, a specifying unit 104, a setting unit 106, a moving unit 108, and an output unit 110 as functional configurations. Each functional configuration is implemented by the CPU 11 reading the obstacle proximity detection program stored in the ROM 12 or the storage 14, developing the program in the RAM 13, and executing the program.

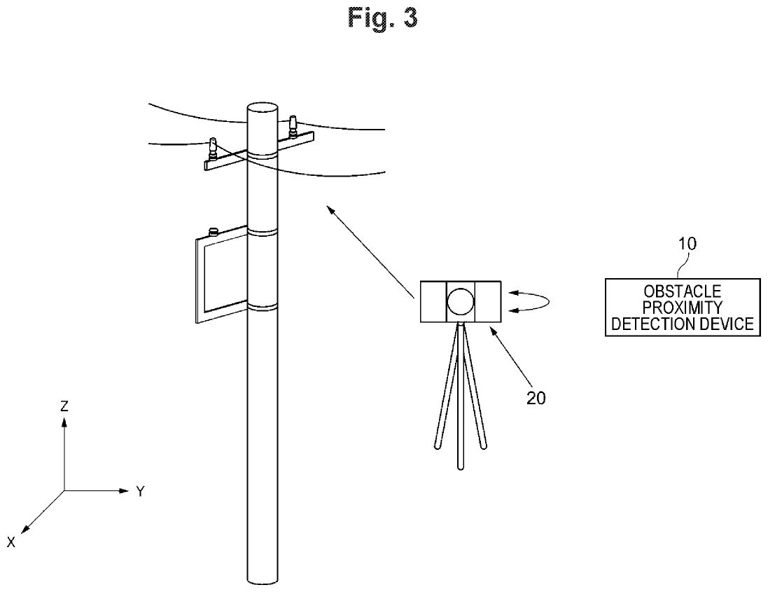

FIG. 3 is a diagram illustrating a relationship between the obstacle proximity detection device 10 and a three-dimensional laser scanner 20. As illustrated in FIG. 3, an east-west direction is an x axis, a north-south direction is a y axis, and an altitude is a z axis with reference to a position of the three-dimensional laser scanner 20. The three-dimensional laser scanner 20 sequentially acquires three-dimensional point cloud data of an outdoor structure, and outputs the three-dimensional point cloud data to the obstacle proximity detection device 10. The obstacle proximity detection device 10 sequentially acquires the three-dimensional point cloud data acquired by the three-dimensional laser scanner 20 and stores the three-dimensional point cloud data in its own data storage unit 100.

The data storage unit 100 sequentially stores the three-dimensional point cloud data representing the outdoor structures acquired by the three-dimensional laser scanner 20. In addition, the data storage unit 100 stores various types of data necessary for executing obstacle proximity detection processing.

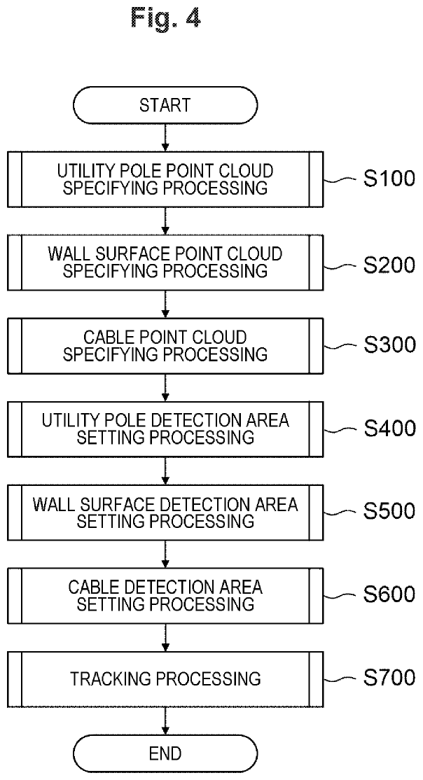

Next, an operation of the obstacle proximity detection device 10 according to the present embodiment will be described with reference to FIGS. 4 to 19.

FIG. 4 is a flowchart illustrating an example of a flow of processing by the obstacle proximity detection program according to the present embodiment. The processing by the obstacle proximity detection program is implemented by the CPU 11 of the obstacle proximity detection device 10 writing the obstacle proximity detection program stored in the ROM 12 or the storage 14 into the RAM 13 and executing the program.

In the present embodiment, a case where the three-dimensional laser scanner 20 sequentially acquires three-dimensional point cloud data of an outdoor structure including a new utility pole under construction of the new utility pole, which is an example of an object, and the obstacle proximity detection device 10 detects proximity between the utility pole and an obstacle will be described as an example.

First, the three-dimensional laser scanner 20 sequentially acquires the three-dimensional point cloud data of the outdoor structure including the new utility pole, and outputs the three-dimensional point cloud data to the obstacle proximity detection device 10 under construction of the new utility pole. Then, the obstacle proximity detection device 10 sequentially stores the three-dimensional point cloud data in the data storage unit 100. When the three-dimensional point cloud data starts to be stored in the data storage unit 100, the obstacle proximity detection device 10 executes processing of FIG. 4.

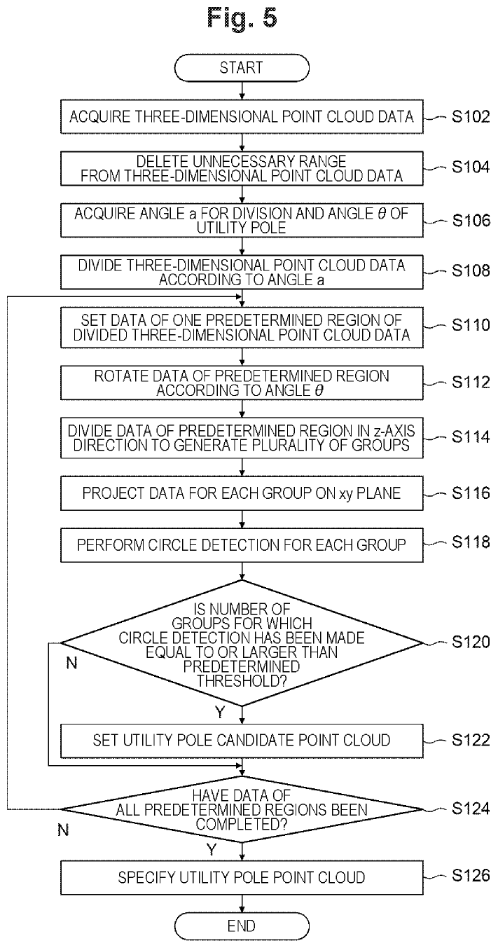

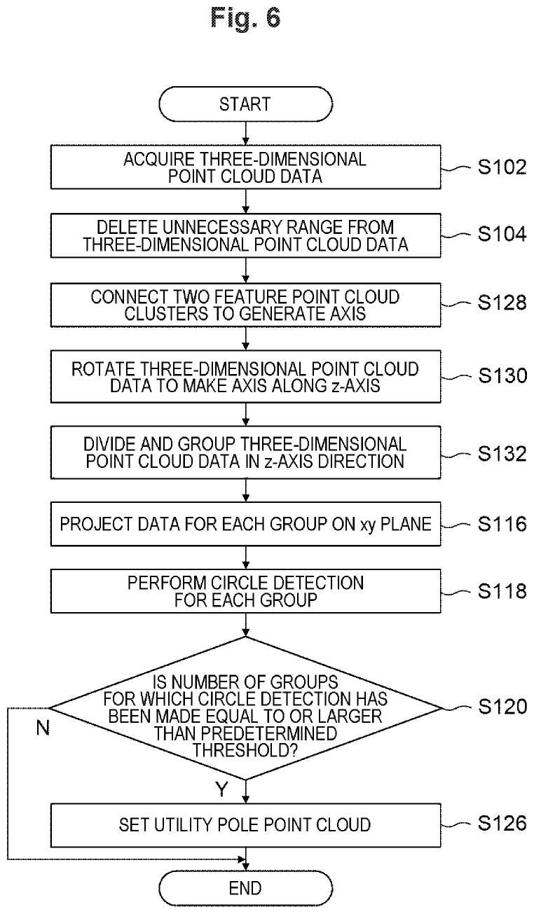

First, in step S100 of FIG. 4, the CPU 11 executes utility pole point cloud specifying processing of specifying the three-dimensional point cloud data of the new utility pole from the three-dimensional point cloud data stored in the data storage unit 100. The utility pole point cloud specifying processing is implemented by FIG. 5 or 6.

In step S102 of FIG. 5, the CPU 11 as the acquisition unit 102 acquires the three-dimensional point cloud data stored in the data storage unit 100.

In step S104, the CPU 11 as the specifying unit 104 deletes the three-dimensional point cloud data in an unnecessary range from the three-dimensional point cloud data acquired in step S102. For example, the three-dimensional point cloud data of a certain distance or more from a measurement point where the three-dimensional laser scanner 20 is located is deleted as data in the unnecessary range.

In step S106, the CPU 11 as the specifying unit 104 acquires an angle a for dividing the three-dimensional point cloud data and an angle θ of the utility pole. As to the angle θ of the utility pole, for example, a worker at a construction site manually inputs the angle θ representing an inclination of the utility pole to the obstacle proximity detection device 10. Note that this angle θ is an angle formed by the z axis on an xyz coordinates illustrated in FIG. 3 and a utility pole P. In the case where the object is a utility pole under construction, a state in which the utility pole is placed on the ground, a state in which the utility pole is held and suspended by a heavy machine, a state in which the utility pole stands by itself, and the like are assumed, and a direction and an angle in which the utility pole faces change depending on the situation. Therefore, it is necessary to acquire the angle θ with reference to the three-dimensional laser scanner 20 in advance. The processing of FIG. 5 is processing when the angle θ is determined by the worker and input to the obstacle proximity detection device 10. Note that it is possible to calculate the angle θ using a known technique by a user inputting distances from the three-dimensional laser scanner 20 to a lower portion and an upper portion of the utility pole to the obstacle proximity detection device 10 in advance. Although the angle θ of the utility pole can be acquired as described above, the direction in which the utility pole is inclined cannot be calculated. Therefore, as will be described below, by rotating each piece of data obtained by dividing the three-dimensional point cloud data at regular intervals by the angle θ, it is possible to specify the utility pole without calculating the direction in which the utility pole is inclined. When specifying the three-dimensional point cloud data representing the utility pole, thresholds may be set for a distance from the three-dimensional laser scanner 20, a size of extracted point cloud, and the like, and the three-dimensional point cloud data representing the utility pole may be specified on the basis of the thresholds.

In step S108, the CPU 11 as the specifying unit 104 divides the three-dimensional point cloud data according to the angle a (0<a<360) acquired in step S106.

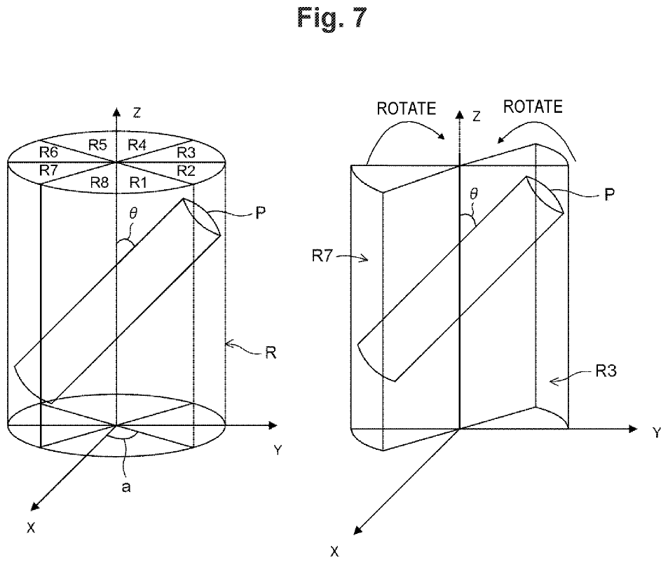

FIG. 7 is a diagram for describing the division of the three-dimensional point cloud data according to the angle a. As illustrated on the left side of FIG. 7, the three-dimensional point cloud data in a predetermined region R is divided according to the angle a on an xy plane on the xyz coordinates. P of FIG. 7 is the three-dimensional point cloud data corresponding to the utility pole under construction. Note that FIG. 7 illustrates a case where the angle a=45 degrees. Note that data i divided for each angle a is an index for identifying data in the predetermined region R, and satisfies 1≤i≤360/a. For example, data in a predetermined region R3 corresponds to data of i=3. In the example illustrated on the left side of FIG. 7, the three-dimensional point cloud data in the predetermined region R is divided into eight predetermined regions R1 to R8. In the following processing, each of the predetermined regions R1 to R8 is rotated by the angle θ of the utility pole so that the three-dimensional point cloud data corresponding to the utility pole is made along the z axis. As a result, it is determined whether the three-dimensional point cloud data is the utility pole.

For example, as illustrated on the right side of FIG. 7, the three-dimensional point cloud data in the predetermined region R3 is rotated by the angle θ with an origin of the xyz coordinates as a starting point. In this case, the utility pole P has a shape along the z axis. In this case, a case where the three-dimensional point cloud data of the utility pole P along the z axis is projected on the xy plane will be considered.

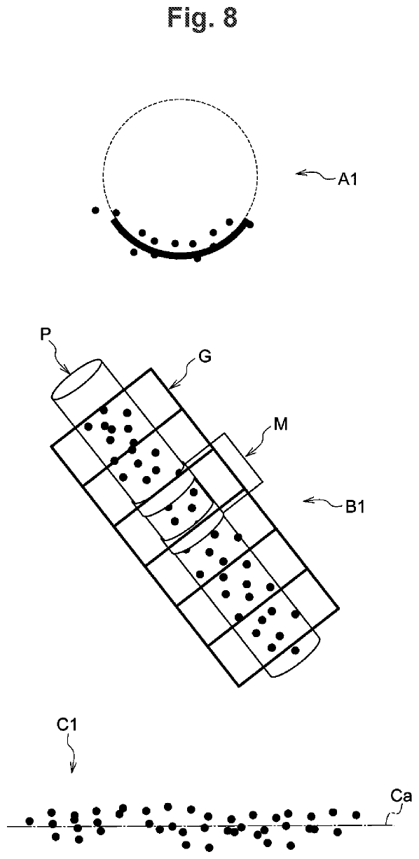

FIG. 8 is a diagram for describing processing of the three-dimensional point cloud data according to the present embodiment. Note that the black circles in FIG. 8 represent the three-dimensional point data. As described above, in the case where the three-dimensional point cloud data of the utility pole P along the z axis is projected on the xy plane, as illustrated in A1 of FIG. 8, a projection result of the three-dimensional point cloud data on the xy plane is a circular shape. Therefore, in the present embodiment, it is determined whether the three-dimensional point cloud data is the utility pole according to whether the projection result on the xy plane thus obtained is a circular shape.

Furthermore, in the present embodiment, as illustrated in B1 of FIG. 8, the three-dimensional point cloud data is divided into groups G that intersect with the z axis, and it is determined whether a circular shape is detected for each group G (hereinafter also simply referred to as “circle detection”). In B1 of FIG. 8, a heavy machine M that grips the utility pole P is also illustrated. In addition, for example, known RANSAC processing or the like is used for detecting a circular shape and detecting a linear shape.

In addition, in the present embodiment, as illustrated in C1 of FIG. 8, when the three-dimensional point cloud data corresponding to ta cable Ca existing between the existing utility poles is determined, the three-dimensional point cloud data is projected onto a predetermined plane, and it is determined whether the three-dimensional point cloud data is a cable according to whether the projection result is a circular shape.

As illustrated on the right side of FIG. 7, in the case where the data of the predetermined region R3 is rotated by the angle θ, the circular shape is detected in the projection result, and thus the data of the predetermined region R3 is specified as a utility pole point cloud. Meanwhile, in the case where the data of the predetermined region R7 is rotated by the angle θ, the circular shape is not detected in the projection result, and thus the data of the predetermined region R7 is specified as not a utility pole point cloud. Even in this case, since the data of the predetermined region R7 partially includes the utility pole, for example, the data of the predetermined region R7 existing at a diagonal position of the data of the predetermined region R3 may also be specified as a utility pole point cloud. Note that the circle detection may be performed for axes in all directions of the three-dimensional point cloud data without using the angle θ of the utility pole.

Specifically, in step S110 of FIG. 5, the CPU 11 as the specifying unit 104 sets data of one predetermined region (for example, the data of the predetermined region R1 or the like) of the divided three-dimensional point cloud data.

In step S112, the CPU 11 as the specifying unit 104 rotates the data of the predetermined region set in step S110 by the angle θ. If the data of the predetermined region is the three-dimensional point cloud data of the utility pole, the data of the predetermined region after the rotation is in the direction along the z axis.

In step S114, the CPU 11 as the specifying unit 104 divides the data of the predetermined region rotated in step S112 in a region intersecting with a z-axis direction to generate a plurality of groups.

In step S116, the CPU 11 as the specifying unit 104 projects the three-dimensional point cloud data belonging to each of the plurality of groups generated in step S114 onto the xy plane.

In step S118, the CPU 11 detects the circular shape on the basis of the projection result for each group obtained in step S116, as the specifying unit 104.

In step S120, the CPU 11 determines whether the number of groups for which the circle detection has been made is equal to or larger than a predetermined threshold, as the specifying unit 104. In a case where the number of groups for which the circle detection has been made is equal to or larger than the predetermined threshold, the processing proceeds to step S122. On the other hand, in a case where the number of groups for which the circle detection has been made is less than the predetermined threshold, the processing proceeds to step S124.

In step S122, the CPU 11 as the specifying unit 104 temporarily stores the data of the predetermined region set in step S110 in the data storage unit 100 as a utility pole candidate point cloud.

In step S124, the CPU 11 determines whether the processing of steps S110 to S122 has been executed for the data of all the predetermined regions divided in step S108, as the specifying unit 104. In a case where the processing of steps S110 to S122 has been executed for the data of all the predetermined regions, the processing proceeds to step S126. In a case where there is the data of the predetermined region for which the processing of steps S110 to S122 has not been executed, the processing returns to step S110.

In step S126, the CPU 11 as the specifying unit 104 specifies the utility pole P by regarding the data of the predetermined region having the largest number of detections of the circular shapes as utility pole point cloud data that is an example of first point cloud data.

Note that the utility pole point cloud specifying processing in step S100 in FIG. 4 is not limited to the processing in FIG. 5, and may be realized by the processing in FIG. 6, for example. In the processing of FIG. 6, the utility pole point cloud data is specified without requiring the input of the angle θ between the z axis on the xyz coordinates and the utility pole P.

Specifically, in step S128, the CPU 11 as the specifying unit 104 executes an existing feature point analysis algorithm for the three-dimensional point cloud data, and specifies a feature point cloud cluster from the three-dimensional point cloud data. The feature point cloud cluster is, for example, a cluster of point clouds of an object having a feature such as high reflection intensity or a unique shape in the three-dimensional point cloud data. For example, it is also possible to specify a scaffolding bolt or a heavy machine grip portion attached to the utility pole or proximity to the utility pole, using the feature point cloud cluster. Alternatively, for example, both ends of the utility pole can be specified using the feature point cloud cluster.

Therefore, in step S128 of FIG. 6, the CPU 11 as the specifying unit 104 generates an axis by connecting two feature point cloud clusters specified as both ends of the utility pole.

Next, in step S130, the CPU 11 as the specifying unit 104 rotates the three-dimensional point cloud data so as to make the axis generated in step S128 along the z axis.

Then, in step S132, the CPU 11 as the specifying unit 104 divides the rotated three-dimensional point cloud data in a region intersecting with the z-axis direction to generate a plurality of groups.

The other processing illustrated in FIG. 6 is similar to that in FIG. 5, and thus description thereof is omitted. Note that the utility pole point cloud data may be specified using both the processing of FIG. 5 and the processing of FIG. 6.

In this way, the utility pole point cloud data, which is an example of the first point cloud data, is specified from the three-dimensional point cloud data. Note that the utility pole point cloud data may be specified by a method different from that in FIGS. 5 and 6. For example, an object having a material or a structure with high reflectance is attached to the utility pole or the heavy machine. Alternatively, an object having a specific shape is mounted on the utility pole or the heavy machine. Then, the axis of the utility pole is calculated according to the positions of the three-dimensional point cloud data of these objects. More specifically, for example, two objects having high reflectance are attached to the grip portion of the heavy machine. Then, for example, the objects may be extracted from the three-dimensional point cloud data, an axis connecting the two objects may be set as a utility pole axis, and the circle detection may be performed to specify the utility pole point cloud data. The utility pole point cloud data may be specified by performing the circle detection for the axes in all directions of the three-dimensional point cloud data without using the angle θ of the utility pole.

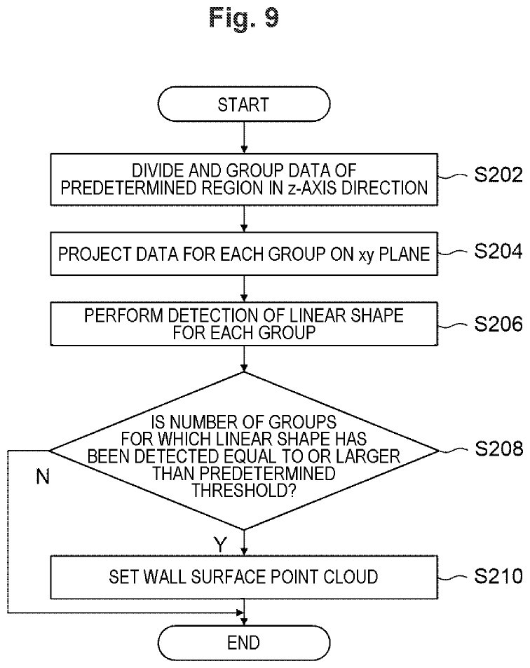

Next, in step S200 of FIG. 4, the CPU 11 executes wall surface point cloud specifying processing of specifying the three-dimensional point cloud data of a wall surface, which is an example of an obstacle, from the three-dimensional point cloud data. The wall surface point cloud specifying processing is implemented by FIG. 9.

In step S202 of FIG. 9, the CPU 11 as the specifying unit 104 divides the input three-dimensional point cloud data in a region intersecting with the z-axis direction to generate a plurality of groups.

In step S204, the CPU 11 as the specifying unit 104 projects the three-dimensional point cloud data belonging to each of the plurality of groups generated in step S202 onto the xy plane.

In step S206, the CPU 11 detects the linear shape on the basis of the projection result for each group obtained in step S204, as the specifying unit 104.

In step S208, the CPU 11 determines whether the number of groups for which the linear shape has been detected is equal to or larger than a predetermined threshold, as the specifying unit 104. In a case where the number of groups for which the linear shape has been detected is equal to or larger than the predetermined threshold, the processing proceeds to step S210. On the other hand, in a case where the number of groups for which the linear shape has been detected is less than the predetermined threshold, the processing is terminated.

In step S210, the CPU 11 as the specifying unit 104 stores the input three-dimensional point cloud data in the data storage unit 100 as wall surface point cloud data that is an example of second point cloud data.

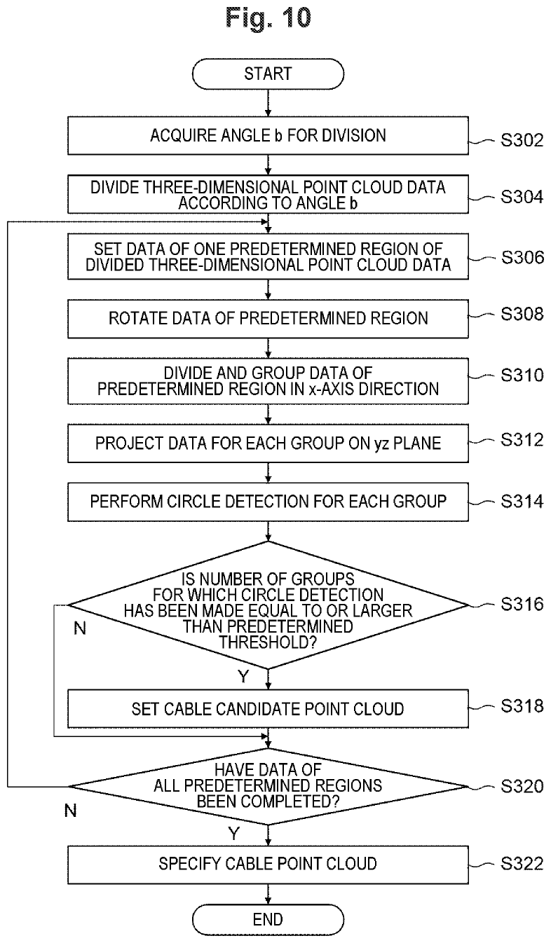

Next, in step S300 of FIG. 4, the CPU 11 executes cable point cloud specifying processing of specifying the three-dimensional point cloud data of a cable, which is an example of an obstacle, from the three-dimensional point cloud data. The cable point cloud specifying processing is implemented by FIG. 10.

In step S302 of FIG. 10, the CPU 11 as the specifying unit 104 acquires an angle b for dividing the input target three-dimensional point cloud data.

In step S304, the CPU 11 as the specifying unit 104 divides the three-dimensional point cloud data according to the angle b acquired in step S302.

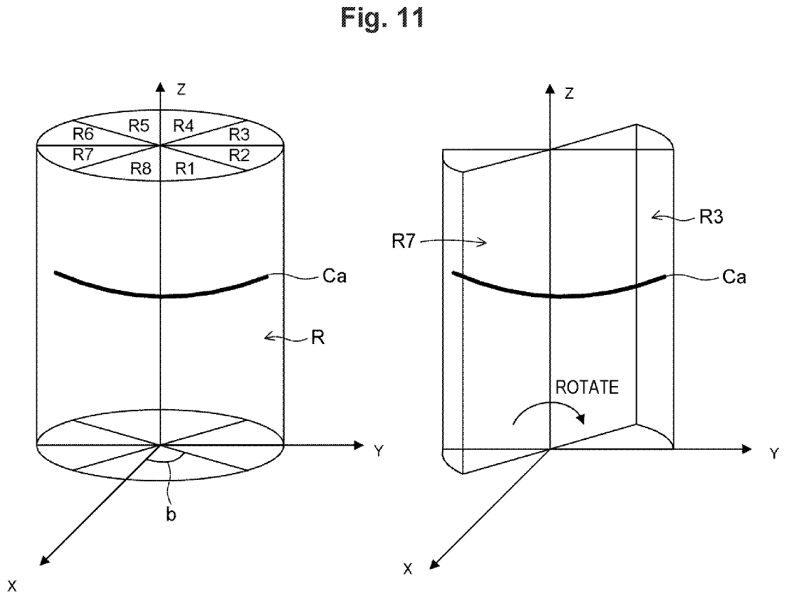

FIG. 11 is a diagram for describing the division of the three-dimensional point cloud data according to the angle b. As illustrated on the left side of FIG. 11, the three-dimensional point cloud data in a predetermined region R is divided according to the angle b on the xy plane on the xyz coordinates. Ca in FIG. 11 is the three-dimensional point cloud data corresponding to an existing cable. Note that FIG. 11 illustrates a case where the angle b=45 degrees. In the example illustrated on the left side of FIG. 11, the three-dimensional point cloud data in the predetermined region R is divided into eight predetermined regions R1 to R8. In the following processing, each of the predetermined regions R1 to R8 is rotated by the angle b about the z axis so that the three-dimensional point cloud data corresponding to the cable is made along the x axis. As a result, it is determined whether the three-dimensional point cloud data is the cable.

For example, as illustrated on the right side of FIG. 11, the three-dimensional point cloud data in the predetermined region R3 is rotated about the z axis by an angle (b*j−b/2). Note that data j is an index for identifying data in the predetermined region R, and satisfies 1≤j≤360/b. For example, data in a predetermined region R3 corresponds to data of j=3. Therefore, the three-dimensional point cloud data in the predetermined region R3 is rotated by (45*3−45/2)=112.5 degrees and is along the x axis.

Then, the three-dimensional point cloud data in the rotated predetermined region R3 is projected on a yz plane, and it is determined whether the three-dimensional point cloud data is the cable according to whether the projection result is a circular shape.

Specifically, in step S306, the CPU 11 as the specifying unit 104 sets data of one predetermined region (for example, the data of the predetermined region R1 or the like) of the divided three-dimensional point cloud data.

In step S308, the CPU 11 as the specifying unit 104 rotates the data of the predetermined region set in step S306 by an angle (b*j−b/2) about the z axis. If the data of the predetermined region is the three-dimensional point cloud data of the cable Ca, the data of the predetermined region after the rotation is in the direction along the x axis.

In step S310, the CPU 11 as the specifying unit 104 divides the data of the predetermined region rotated in step S308 in a region intersecting with an x-axis direction to generate a plurality of groups.

In step S312, the CPU 11 as the specifying unit 104 projects the three-dimensional point cloud data belonging to each of the plurality of groups generated in step S310 onto the yz plane.

In step S314, the CPU 11 as the specifying unit 104 detects the circular shape on the basis of the projection result for each group obtained in step S312.

In step S316, the CPU 11 as the specifying unit 104 determines whether the number of groups for which the circle detection has been made is equal to or larger than a predetermined threshold. In a case where the number of groups for which the circle detection has been made is equal to or larger than the predetermined threshold, the processing proceeds to step S318. On the other hand, in a case where the number of groups for which the circle detection has been made is less than the predetermined threshold, the processing proceeds to step S320.

In step S318, the CPU 11 as the specifying unit 104 temporarily stores the data of the predetermined region set in step S306 in the data storage unit 100 as a cable candidate point cloud.

In step S320, the CPU 11 as the specifying unit 104 determines whether the processing of steps S306 to S318 has been executed for the data of all the predetermined regions divided in step S304. In a case where the processing of steps S306 to S318 has been executed for the data of all the predetermined regions, the processing proceeds to step S322. In a case where there is the data of the predetermined region for which the processing of steps S306 to S318 has not been executed, the processing returns to step S306.

In step S322, the CPU 11 as the specifying unit 104 specifies the cable by regarding the data of the predetermined region having the largest number of detections of the circular shapes as a cable point cloud that is an example of the second point cloud data. As described above, when cable point cloud data is specified, the circle detection is performed in parallel with the ground, and when the wall surface point cloud data is specified, straight line detection is performed perpendicularly to the ground. Note that, in the above description, the cases where the utility pole point cloud data, the wall surface point cloud data, and the cable point cloud data are automatically specified have been described as examples. However, for example, the utility pole point cloud data, the wall surface point cloud data, the cable point cloud data, and the like may be manually extracted by the user and labeled to identify each data.

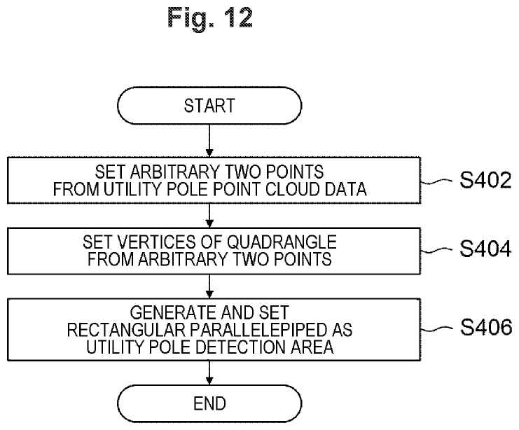

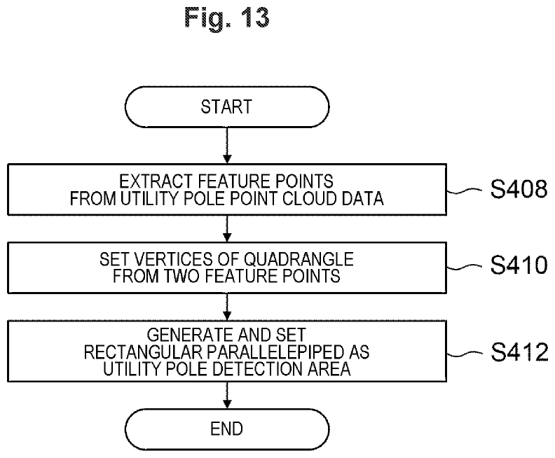

Next, in step S400 of FIG. 4, the CPU 11 executes utility pole detection area setting processing for setting a utility pole detection area, which is an example of a first detection area, for the utility pole point cloud data. The utility pole detection area setting processing is implemented by FIG. 12 or 13. In the processing of FIG. 12, the utility pole detection area is set by the user such as a worker at a construction site.

In step S402 of FIG. 12, the CPU 11 as the setting unit 106 acquires data of arbitrary two points set in advance by the user. The data of these two points is the three-dimensional point data included in the utility pole point cloud data. Then, the CPU 11 as the setting unit 106 sets the data of the arbitrary two points for the utility pole point cloud data.

In step S404, the CPU 11 as the setting unit 106 sets vertices of a quadrangle on the basis of the data of the two points set in step S402.

In step S406, the CPU 11 as the setting unit 106 sets the utility pole detection area that is an area around the utility pole point cloud data on the basis of the vertices of the quadrangle set in step S404.

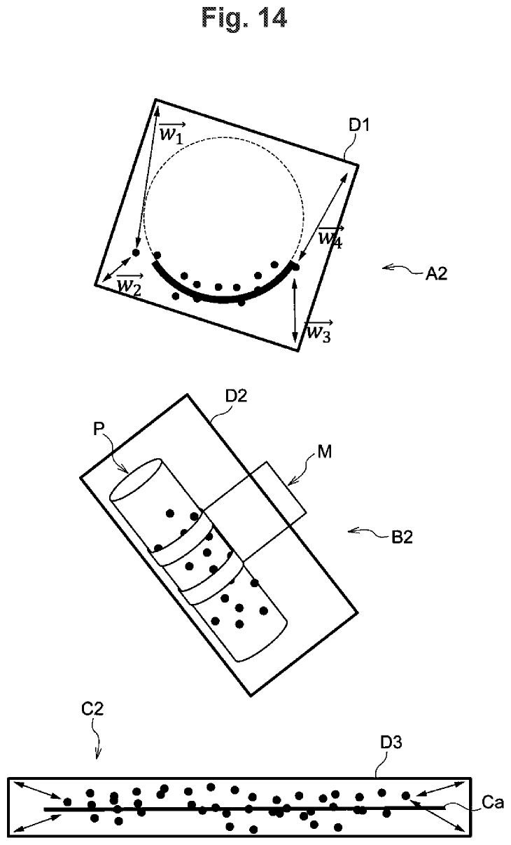

FIG. 14 is a diagram for describing setting of a utility pole detection area. As illustrated in A2 of FIG. 14, in a case where the circle of the utility pole is viewed from above, and in a case where arbitrary two points of the utility pole point cloud data are set by the user, for example, vertices of the utility pole detection area are set at positions of vectors expressed by the following equation from the two points.

$$\vec{{w}_{n}} = ( {x}_{n} , {y}_{n} , {z}_{n} ) \qquad [ Math . 1 ]$$

In A2 of FIG. 14, as an example, four vertices corresponding to four vectors w₁, w₂, w₃, and w₄ of the utility pole detection area are set in certain directions and positions from two end points forming one circle, and a quadrangle D1 corresponding to the four vertices is set. Then, as illustrated in A2 of FIG. 14, by setting lines (a depth direction and a front direction in A2 of FIG. 14) having arbitrary lengths perpendicular to the circle from the four vertices of the quadrangle D1, a cube D2 as illustrated in B2 of FIG. 14 is set as the utility pole detection area.

Alternatively, arbitrary vertices may be set on the basis of feature points in an uppermost stage and a lowermost stage of the utility pole point cloud data, and points connected along an axis of a cylindrical object represented by the utility pole point cloud data may be connected to each other to form the utility pole detection area.

By setting the utility pole detection area by the above-described method, it is possible to automatically track the utility pole point cloud data and the utility pole detection area even when the direction of the circle forming the utility pole point cloud data changes. Note that, in the above description, a case where two points of data are set by the user has been described as an example, but detection areas (the utility pole detection area, and a cable detection area and a wall surface detection area to be described below) may be set by the user by a method different from the above example.

In addition, as illustrated in C2 of FIG. 14, it is also possible to set the cable detection area for the cable point cloud data representing the cable Ca by a method similar to the above-described method. C2 of FIG. 14 illustrates a case where a linear portion representing an obstacle is the cable Ca, but the linear portion representing an obstacle may be a wall viewed from above. In this case, as described above, the wall surface point cloud data is specified by performing the straight line detection, and the wall surface detection area is set for the wall surface point cloud data. As described above, when the cable point cloud data is specified, the circle detection is performed in parallel with the ground, but the cable point cloud data may be specified by performing the straight line detection similarly to the specification of the wall surface point cloud data.

Meanwhile, in the processing of FIG. 13, the utility pole detection area is automatically set. Specifically, in the processing of FIG. 13, a feature point cloud is extracted from the utility pole point cloud data, a predetermined height and a predetermined width are set for the feature points included in the feature point cloud, and the area is set as the utility pole detection area. Since the feature points (for example, a scaffolding bolt, a lifting rope, a grip portion of a heavy machine, or an outer edge portion of a utility pole) extracted from such three-dimensional point cloud data rarely enter a blind spot even during construction work, tracking in tracking processing to be described below becomes relatively easy. In addition, when this method is adopted, tracking of only the feature points may be sufficient, and thus a calculation time can be shortened. In this case, to perfectly track the utility pole point cloud data during construction, it is considered necessary to acquire the three-dimensional point cloud data of outer shapes of all the utility poles.

In step S408 of FIG. 13, the CPU 11 as the setting unit 106 extracts the feature point cloud data that is a plurality of feature points from the utility pole point cloud data.

In step S410, the CPU 11 as the setting unit 106 selects two feature points (for example, feature points representing the outer edge portion of the utility pole) from the feature point cloud data extracted in step S408, and sets vertices of a quadrangle from the two feature points.

In step S412, the CPU 11 as the setting unit 106 sets the utility pole detection area that is an area around the utility pole point cloud data on the basis of the vertices of the quadrangle set in step S410.

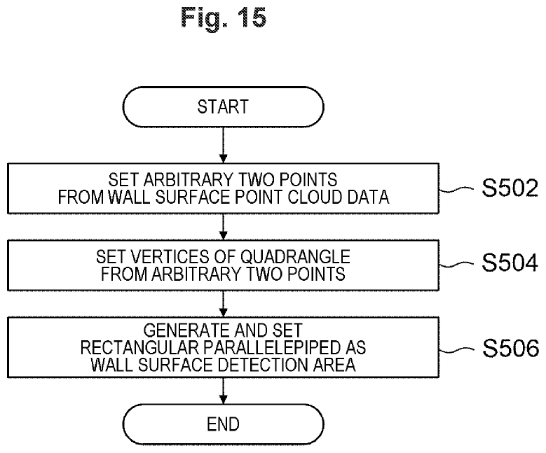

Next, in step S500 of FIG. 4, the CPU 11 executes wall surface detection area setting processing for setting the wall surface detection area, which is an example of a second detection area, for the wall surface point cloud data, which is the second point cloud data. The wall surface detection area setting processing is implemented by FIG. 15.

In step S502 of FIG. 15, the CPU 11 as the setting unit 106 selects data of arbitrary two points from the wall surface point cloud data. Note that the selection of the data of two points may be performed by the user.

In step S504, the CPU 11 as the setting unit 106 sets vertices of a quadrangle on the basis of the data of the two points set in step S502.

In step S506, the CPU 11 as the setting unit 106 sets the wall surface detection area that is an area around the wall surface point cloud data on the basis of the vertices of the quadrangle set in step S504.

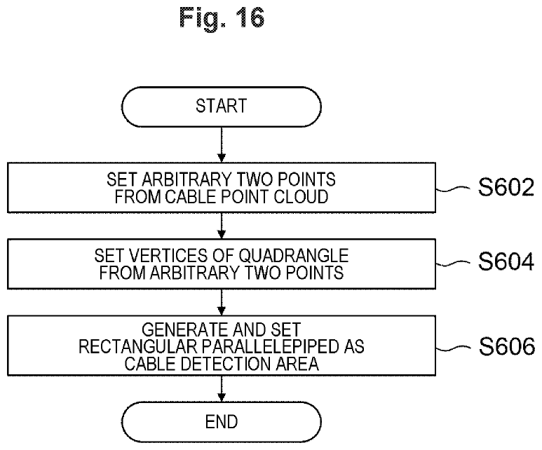

Next, in step S600 of FIG. 4, the CPU 11 executes cable detection area setting processing for setting the cable detection area, which is an example of the second detection area, for the cable point cloud data, which is the second point cloud data. The cable detection area setting processing is implemented by FIG. 16.

In step S602 of FIG. 16, the CPU 11 as the setting unit 106 selects data of arbitrary two points from the cable point cloud data. Note that the selection of the data of two points may be performed by the user.

In step S604, the CPU 11 as the setting unit 106 sets vertices of a quadrangle on the basis of the data of the two points set in step S602.

In step S606, the CPU 11 as the setting unit 106 sets the cable detection area that is an area around the cable point cloud data on the basis of the vertices of the quadrangle set in step S604.

Note that the wall surface detection area setting processing of FIG. 15 and the cable detection processing of FIG. 16 may be performed in a manner similar to the utility pole detection area setting processing of FIG. 12 or 13.

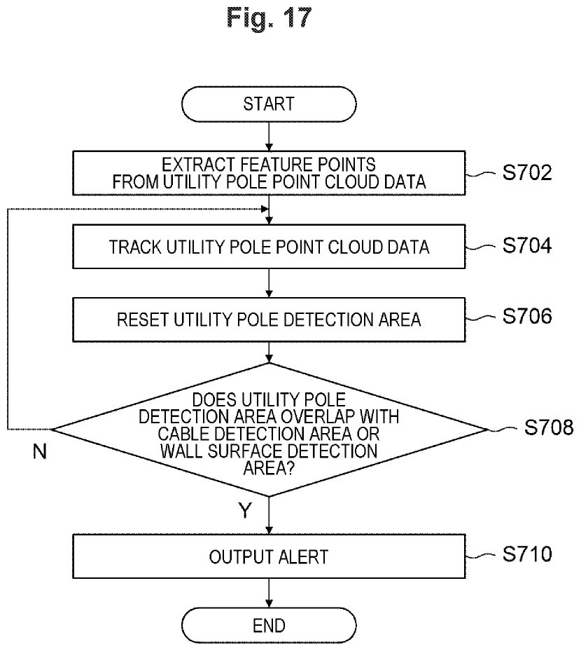

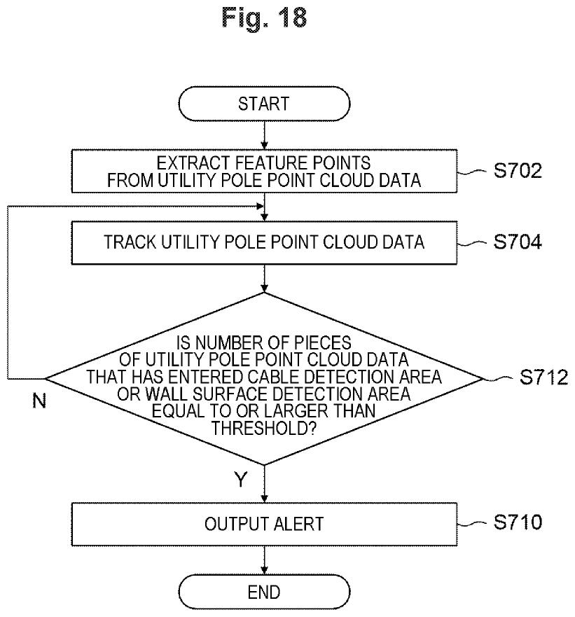

Next, in step S700 of FIG. 4, the CPU 11 performs tracking processing of tracking the utility pole point cloud data and outputting an alert when a predetermined condition is satisfied. The tracking processing is implemented by FIG. 17 or 18.

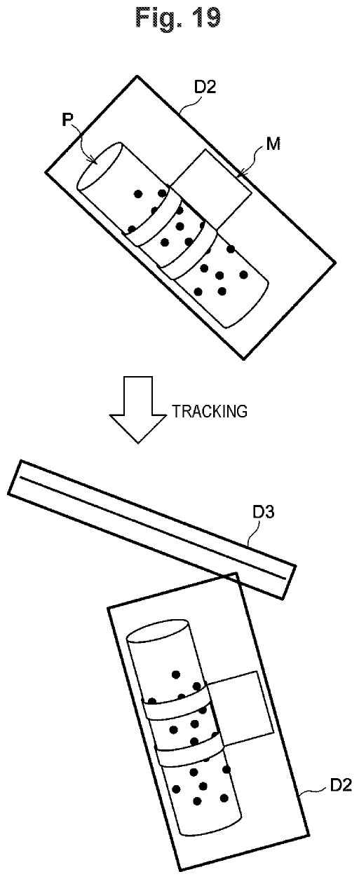

FIG. 19 illustrates a diagram for describing alert output processing. For example, as illustrated in FIG. 19, when a utility pole detection area D2 moves and the utility pole detection area D2 and a cable detection area D3 overlap with each other, an alert indicating the proximity between the utility pole and the cable is output.

In step S702 of FIG. 17, the CPU 11 as the moving unit 108 extracts a plurality of feature points from the utility pole point cloud data.

In step S704, the CPU 11 as the moving unit 108 moves the utility pole point cloud data according to the movement of the plurality of feature points extracted in step S702. Accordingly, tracking of the utility pole point cloud data is implemented.

In step S706, the CPU 11 as the moving unit 108 resets the utility pole detection area according to the utility pole point cloud data moved in step S704. As a result, the utility pole detection area also moves according to the movement of the utility pole point cloud data.

In step S708, the CPU 11 as the output unit 110 determines whether the utility pole detection area and the obstacle area (representing at least one of the cable detection area or the wall surface detection area) overlap. In a case where the utility pole detection area and the obstacle area overlap, the processing proceeds to step S710. In a case where the utility pole detection area and the obstacle area do not overlap, the processing returns to step S704.

In step S708, the CPU 11 as the output unit 110 may proceed to step S710 in a case where magnitude of a volume of the overlapping utility pole detection area and obstacle detection area exceeds a threshold.

In step S710, the CPU 11 as the output unit 110 outputs the alert indicating the proximity between the utility pole and the wall surface or the cable. The alert output from the output unit 110 is output in a format (for example, sound or display) recognizable by the user by a sound output device (not illustrated) or a display device (not illustrated).

The alert output processing may be implemented by the processing of FIG. 18.

In step S712 of FIG. 18, in a case where the utility pole point cloud data enters the cable detection area or the wall surface detection area, the CPU 11 as the output unit 110 determines whether the number of pieces of the three-dimensional point cloud data is equal to or larger than a threshold. In the case where the number of pieces of three-dimensional point cloud data of the utility pole point cloud data that has entered the cable detection area or the wall surface detection area is equal to or larger than the threshold, the processing proceeds to step S710. In the case where the number of pieces of three-dimensional point cloud data of the utility pole point cloud data that has entered the cable detection area or the wall surface detection area is less than the threshold, the processing returns to step S704. In this case, setting of the utility pole detection area is not necessary. This is because which point cloud data is the utility pole point cloud data in the three-dimensional point cloud data is grasped by tracking of the utility pole point cloud data.

When the worker at the construction site confirms the alert, for example, the worker stops the heavy machine that is moving the utility pole.

In the alert output processing of FIGS. 17 and 18, the feature points (for example, the scaffolding bolt, the lifting rope, or the grip portion of the heavy machine) are extracted from the utility pole point cloud data, and the utility pole point cloud data is tracked by tracking the feature points. The scaffolding bolt has a shape in which several straight lines are provided from a cylindrical object. In addition, the lifting rope and the grip portion of the heavy machine have shapes in which the diameter of a cylindrical object is partially increased. Therefore, it is possible to track the utility pole point cloud data by extracting these parts as the feature points. In addition, it is possible to also move the utility pole detection area at the same time by maintaining these feature points and a positional relationship between the end points and the vertices initially set. Specifically, it is possible to maintain the initially defined positional relationship by specifying the positions of the circles included in the utility pole point cloud data while tracking the feature points. When the vertex is redefined, the vector wₙ is automatically corrected according to the position of the circle. As a method of tracking the feature point, a known method for feature amount calculation such as SHOT, PCL, or Spinimage can be used.

In the present embodiment, another object (for example, the cable or the wall surface) different from the utility pole is regarded as a stationary object and is not tracked. For the another object (for example, the cable or the wall surface) different from the utility pole, the initially set obstacle detection area is used. In this way, it is possible to accurately reset the detection area by focusing on a feature amount at the time of construction and performing tracking. In addition, in the alert output processing of FIG. 18, since the utility pole detection area is not fixed, it is possible to set the same to a moving object and to perform sensing with a high degree of freedom.

As described above, the obstacle proximity detection device sequentially acquires the three-dimensional point cloud data representing an outdoor structure acquired by the three-dimensional laser scanner. Then, the obstacle proximity detection device specifies, from the three-dimensional point cloud data, the first point cloud data representing a utility pole under construction, which is an example of the object, and the second point cloud data representing a cable or a wall surface, which is an example of the obstacle. The obstacle proximity detection device sets the first detection area that is an area set in advance by the user and is an area around the first point cloud data. The obstacle proximity detection device moves the first point cloud data and the first detection area according to the movement of the feature point on the basis of the feature point extracted from the first point cloud data. In a case where a part of the first detection area and a part of the second detection area, which is an area around the second point cloud data, overlap with each other, or in a case where the number of pieces of point data of the first point cloud data existing in the second detection area is equal to or larger than a predetermined threshold, the obstacle proximity detection device outputs the alert indicating the proximity between the utility pole under construction and the cable or the wall surface. As a result, it is possible to detect the proximity between the moving object and another obstacle in real time. Specifically, the technique of Patent Literature 1, which is a conventional technique, lacks real-time properties, and the technique of Patent Literature 2 has a problem that it is necessary to acquire the number of pieces of three-dimensional point data that can be detected as an object within a preset detection area. Specifically, in the technique disclosed in Patent Literature 2, the detection area is designated in advance, and when the three-dimensional point cloud data can be acquired to some extent, it is detected as an object. In contrast, the obstacle proximity detection device according to the present embodiment enables accurate sensing in real time by moving the utility pole detection area after specifying the utility pole point cloud data. In addition, by focusing on the feature point when the utility pole is being constructed and performing tracking, it is possible to accurately reset the utility pole detection area. In addition, since the detection area can also be set for a moving object such as the utility pole under construction, sensing with a high degree of freedom can be performed. In addition, since the three-dimensional point cloud data recognized in advance is tracked, it is possible to determine whether the utility pole point cloud data has entered the cable detection area or the wall surface detection area, for example.

The obstacle proximity detection processing executed by the CPU 11 reading the obstacle proximity detection program in the above embodiment may be executed by various processors other than the CPU 11. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing specific processing, such as an application specific integrated circuit (ASIC). In addition, the obstacle proximity detection processing may be performed by one of these various processors, or may be performed by a combination of two or more processors of the same type or different types (for example, a plurality of FPGAs, a combination of a CPU and an FPGA, and the like). Furthermore, a hardware structure of these various processors is, more specifically, an electric circuit in which circuit elements such as semiconductor elements are combined.

Further, in the above embodiment, the aspect in which the obstacle proximity detection program is stored (also referred to as “installed”) in advance in the ROM 12 or the storage 14 has been described, but the present embodiment is not limited thereto. The obstacle proximity detection program may be provided in a form stored in a non-transitory storage medium such as a compact disk read only memory (CD-ROM), a digital versatile disk read only memory (DVD-ROM), or a universal serial bus (USB) memory. In addition, the obstacle proximity detection program may be downloaded from an external device via a network.

All documents, patent applications, and technical standards described in this specification are incorporated herein by reference to the same extent as when a case where incorporation by reference of each document, patent application, and technical standard is specifically and individually described.

With regard to the above embodiments, the following supplements will be further disclosed.

### (Supplement 1)

An obstacle proximity detection device including:
a memory; and
at least one processor connected to the memory, in which
the processor is configured to
sequentially acquire three-dimensional point cloud data representing an outdoor structure acquired by a three-dimensional laser scanner,
specify first point cloud data representing an object and second point cloud data representing an obstacle from the three-dimensional point cloud data,
set a first detection area that is an area set in advance by a user and is an area around the first point cloud data,
move, on the basis of a feature point extracted from the first point cloud data, the first point cloud data and the first detection area according to movement of the feature point, and
output an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

### (Supplement 2)

A non-transitory storage medium storing a program executable by a computer to execute obstacle proximity detection processing,
the obstacle proximity detection processing including:
sequentially acquiring three-dimensional point cloud data representing an outdoor structure acquired by a three-dimensional laser scanner;
specifying first point cloud data representing an object and second point cloud data representing an obstacle from the three-dimensional point cloud data;
setting a first detection area that is an area set in advance by a user and is an area around the first point cloud data;
moving, on the basis of a feature point extracted from the first point cloud data, the first point cloud data and the first detection area according to movement of the feature point; and
outputting an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

### REFERENCE SIGNS LIST

10 Obstacle proximity detection device
20 Three-dimensional laser scanner
100 Data storage unit
102 Acquisition unit
104 Specifying unit
106 Setting unit
108 Moving unit
110 Output unit

1. An obstacle proximity detection device comprising:
an acquisition unit configured to sequentially acquire three-dimensional point cloud data representing an outdoor structure acquired by a three-dimensional laser scanner;
a specifying unit configured to specify first point cloud data representing an object and second point cloud data representing an obstacle from the three-dimensional point cloud data;
a setting unit configured to set a first detection area that is an area set in advance by a user and is an area around the first point cloud data;
a moving unit configured to move, on the basis of a feature point extracted from the first point cloud data, the first point cloud data and the first detection area according to movement of the feature point; and
an output unit configured to output an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

2. The obstacle proximity detection device according to claim 1, wherein
the object is a utility pole under construction, and
the obstacle is a cable or a wall surface existing between existing utility poles.

3. The obstacle proximity detection device according to claim 1, wherein,
in specifying the first point cloud data, the specifying unit rotates data of a predetermined region included in the three-dimensional point cloud data by a predetermined angle with respect to an xy plane, projects the rotated data of the predetermined region with respect to the xy plane, and specifies the data of the predetermined region as the first point cloud data in a case where the data of the predetermined region projected on the xy plane is circular.

4. The obstacle proximity detection device according to claim 2, wherein,
in specifying second point cloud data representing the cable, the specifying unit rotates data of a predetermined region included in the three-dimensional point cloud data by a predetermined angle about a z axis, projects the rotated data of the predetermined region on a yz plane, and specifies the data of the predetermined region as the second point cloud data representing the cable in a case where the data of the predetermined region projected on the yz plane is circular.

5. The obstacle proximity detection device according to claim 2, wherein,
in specifying second point cloud data representing the wall surface, the specifying unit projects data of a predetermined region included in the three-dimensional point cloud data on an xy plane, and specifies the data of the predetermined region as the second point cloud data representing the wall surface in a case where the data of the predetermined region projected on the xy plane has a linear shape.

6. An obstacle proximity detection method in which a computer executes processing of:
sequentially acquiring three-dimensional point cloud data representing an outdoor structure acquired by a three-dimensional laser scanner;
specifying first point cloud data representing an object and second point cloud data representing an obstacle from the three-dimensional point cloud data;
setting a first detection area that is an area set in advance by a user and is an area around the first point cloud data;
moving, on the basis of a feature point extracted from the first point cloud data, the first point cloud data and the first detection area according to movement of the feature point; and
outputting an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

7. A computer-readable non-transitory recording medium storing computer-executable program instructions that when executed by a processor cause a computer to execute an obstacle proximity detection program to execute processing of:
sequentially acquiring three-dimensional point cloud data representing an outdoor structure acquired by a three-dimensional laser scanner;
specifying first point cloud data representing an object and second point cloud data representing an obstacle from the three-dimensional point cloud data;
setting a first detection area that is an area set in advance by a user and is an area around the first point cloud data;
moving, on the basis of a feature point extracted from the first point cloud data, the first point cloud data and the first detection area according to movement of the feature point; and
outputting an alert indicating proximity between the object and the obstacle in a case where a part of the first detection area overlaps with a part of a second detection area that is an area around the second point cloud data, or in a case where the number of pieces of point data of the first point cloud data existing in the second detection area is equal to or larger than a predetermined threshold.

8. The obstacle proximity detection method according to claim 6, wherein
the object is a utility pole under construction, and
the obstacle is a cable or a wall surface existing between existing utility poles.

9. The obstacle proximity detection method according to claim 6, wherein,
in specifying the first point cloud data, the specifying unit rotates data of a predetermined region included in the three-dimensional point cloud data by a predetermined angle with respect to an xy plane, projects the rotated data of the predetermined region with respect to the xy plane, and specifies the data of the predetermined region as the first point cloud data in a case where the data of the predetermined region projected on the xy plane is circular.

10. The obstacle proximity detection method according to claim 8, wherein,
in specifying second point cloud data representing the cable, the specifying unit rotates data of a predetermined region included in the three-dimensional point cloud data by a predetermined angle about a z axis, projects the rotated data of the predetermined region on a yz plane, and specifies the data of the predetermined region as the second point cloud data representing the cable in a case where the data of the predetermined region projected on the yz plane is circular.

11. The obstacle proximity detection method according to claim 8, wherein,
in specifying second point cloud data representing the wall surface, the specifying unit projects data of a predetermined region included in the three-dimensional point cloud data on an xy plane, and specifies the data of the predetermined region as the second point cloud data representing the wall surface in a case where the data of the predetermined region projected on the xy plane has a linear shape.

12. The computer-readable non-transitory recording medium according to claim 7 wherein the obstacle proximity detection method further comprising:
the object is a utility pole under construction, and
the obstacle is a cable or a wall surface existing between existing utility poles.

13. The computer-readable non-transitory recording medium according to claim 7 wherein the obstacle proximity detection method further comprising:
in specifying the first point cloud data, the specifying unit rotates data of a predetermined region included in the three-dimensional point cloud data by a predetermined angle with respect to an xy plane, projects the rotated data of the predetermined region with respect to the xy plane, and specifies the data of the predetermined region as the first point cloud data in a case where the data of the predetermined region projected on the xy plane is circular.

14. The computer-readable non-transitory recording medium according to claim 12 wherein the obstacle proximity detection method further comprising:
in specifying second point cloud data representing the cable, the specifying unit rotates data of a predetermined region included in the three-dimensional point cloud data by a predetermined angle about a z axis, projects the rotated data of the predetermined region on a yz plane, and specifies the data of the predetermined region as the second point cloud data representing the cable in a case where the data of the predetermined region projected on the yz plane is circular.

15. The computer-readable non-transitory recording medium according to claim 15 wherein the obstacle proximity detection method further comprising:
in specifying second point cloud data representing the wall surface, the specifying unit projects data of a predetermined region included in the three-dimensional point cloud data on an xy plane, and specifies the data of the predetermined region as the second point cloud data representing the wall surface in a case where the data of the predetermined region projected on the xy plane has a linear shape.

16. The obstacle proximity detection device according to claim 1, wherein the alert is generated on a sound output device or on a display device in a format recognizable by the user.

17. The obstacle proximity detection device according to claim 3, wherein the alert is set to generate on a fixed obstacle or on a moving object exist within the predetermined region.

18. The obstacle proximity detection device according to claim 1, wherein sequentially acquires three-dimensional point cloud data representing an outdoor structure acquired by a three-dimensional laser scanner, in which the three-dimensional point cloud data is used to generate a first point cloud data and a second point cloud data.

19. The obstacle proximity detection device according to claim 18, wherein a plurality of feature point group clusters is identified from the three-dimensional point group cloud data.

20. The obstacle proximity detection device according to claim 19, wherein the plurality of feature point group clusters further comprising an object having high reflection intensity or a unique shape among the three-dimensional point group data.
